(19) United States
(12) Patent Application Publication
(10) Pub. No.: US 2010/0220391 A1
(43) Pub. Date: Sep. 2, 2010

(54) LENTICULAR LENS SHEET

(75) Inventors: Yoshio Abe, Niigata (JP); Youji Ono, Niigata (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kuraray Co., Ltd., Kurashiki-shi (JP)

(21) Appl. No.: 11/997,751

(22) PCT Filed: Jul. 31, 2006
(86) PCT No.: PCT/JP2006/315131

§ 371 Date: May 5, 2008

(30) Foreign Application Priority Data
Aug. 5, 2005 (JP) 2005-228620

(51) Int. Cl. G03B 21/62; G02B 27/12

(52) U.S. Cl. 359/456; 359/619

(57) ABSTRACT

A lenticular lens sheet including: rows of cylindrical lenses on an incident surface side; protrusions on sections of the lens rows where light is not condensed; and light absorption layers on the protrusions. The pitch of the lens rows is smaller than 0.5 mm, the angle between the lowermost section of the protrusion and a sheet main surface is equal to or greater than 45° and is greater than the angle formed between the vertex of the protrusion and the sheet main surface, and the width of the protrusion measured at a position 10 μm away in the sheet thickness direction from the vertex of the protrusion is equal to or smaller than 150 μm. A light shielding layer thick enough formed on the protrusion of a lenticular lens can be easily and uniformly formed even if the pitch of the lenticular lens rows is small, and thereby contrast of external light can be enhanced.

### TECHNICAL FIELD

The present invention relates to a lenticular lens sheet forming a rear projection screen used for a rear projection television and others.

### BACKGROUND ART

For a rear projection display, a rear projection type projector, Fresnel lens and a lenticular lens of a longitudinal stripe have been used. FIG. 1 is a sectional view showing one example of the configuration of a rear projection screen. As shown in FIG. 1, a rear projection screen 1 is provided with a lenticular lens sheet 11, a Fresnel lens sheet 12 and a light shielding pattern 13.

The lenticular lens sheet 11 is provided with a lenticular lens 110 on the incident surface side. The lenticular lens 110 includes plural semicylindrical lens longitudinally longer than the width and the semicylindrical lens are arranged at equal intervals. The Fresnel lens sheet 12 is provided with Fresnel lens 120 on the outgoing surface side. The Fresnel lens 120 includes protrusions concentrically arranged at minute pitch of an equal interval. The light shielding pattern 13 is a light absorption layer made of black ink and others and is provided to a section except a section where light is focused by the lenticular lens 110.

As shown in FIG. 1, the lens sheets 11 and 12 are located close and the rear projection screen 1 is configured by these. In the rear projection screen 1, light from a rear projection type projector not shown is incident from the reverse side of the Fresnel lens 120. The incident light is transmitted in the Fresnel lens sheet 12 and is outgoing on the side of the Fresnel lens 120. The outgoing parallel light or converged light is greatly diffused horizontally by the lenticular lens sheet 11. Hereby, a projected image can be observed in a horizontal wide visual field range.

In the lenticular lens, the light shielding pattern is formed on an outgoing surface to improve the contrast of external light. For a method of forming the light shielding pattern on the lenticular lens sheet, protrusions are provided to the outgoing surface side of the lenticular lens sheet, and screen printing, roll printing and others are applied to the protrusions. These protrusions are required to have shapes which do not shield video light outgoing from the lenticular lens.

Recently, for the rear projection type projector, a rear projection display using a liquid crystal display (hereinafter called LCD) and a digital micro mirror device (hereinafter called DMD) is also widely used.

Though the pitch of lens rows in the lenticular lens is heretofore 1 to 0.5 mm, a lenticular lens sheet in which the pitch of lens rows is shorter than 0.5 mm is recently demanded for the fineness of a projected image.

Further, in the rear projection display using LCD and DMD for an image source, a fault of moiré may occur because of the periodic structure of a screen. To avoid the fault of moiré, the pitch of the lenticular lens has a tendency to be smaller and smaller like 0.3 mm or less.

However, as for a conventional type lenticular lens provided with protrusions, when ink is applied to a convex light shielding part of the lenticular lens having short pitch, the thickness of ink at a corner shown by an arrow of the convex light shielding part is not enough as shown in FIG. 4 and nonuniformity is liable to occur in the thickness of ink. Therefore, the contrast of external light is deteriorated. It is believed to be because the surface tension of ink has an effect upon the deterioration of the contrast.

FIG. 2 shows relation between the pitch of lens rows and the thickness of ink. A lenticular lens having the shape shown in FIG. 4 where the width of a light shielding layer is 70% of the pitch is produced and black ink is applied to the light shielding layer by a roll coater. It is found out that when the pitch of the lenticular lens becomes small, the thickness of ink decreases as a whole as shown in FIG. 2 and the contrast has a tendency to be deteriorated.

Further, FIG. 3 shows one example of a result acquired by evaluating the thickness of applied ink and light transmittance. When the thickness of applied ink is 4 μm or smaller, light transmittance rapidly increases. This shows that external light cannot be sufficiently absorbed.

Carbon pigment and others are generally used for light shielding material in ink; however, since the mixed ratio of pigment is limited when applicability and hardenability are considered, it is important in the improvement of contrast that the thickness of ink is increased to acquire sufficient blackness.

When the thickness of ink applied to the lenticular lens sheet is simply increased to increase the thickness of ink, the thickness of ink at a vertex is excessive in the case of the lenticular lens provided with the conventional type trapezoidal protrusions shown in FIG. 4 and a problem may occur in the hardenability of ink. In the meantime, the thickness of ink is not enough in the part shown by the arrow in FIG. 4 and the effect of improving contrast may not be acquired.

In the case of the shape of a protrusion disclosed in Japanese Utility Model No. 1984-87042, as the inclination of the bottom of the protrusion is gentle though the effect of not shielding video light is produced, the thickness of ink applied to an inclined part decreases and contrast is deteriorated. The shorter the pitch of lens rows in a lenticular lens is, the more serious the problem of nonuniformity in the thickness of ink is.

Besides, a method of fine pitch printing in which a light shielding layer is transferred utilizing stickiness is disclosed in JP-A No. 1997-120101, however, the process is complicated. In transfer printing, a film for protecting a transferred sheet and a base film are required and the transfer printing also has a problem that a lot of waste is produced.

Therefore, a simple method of uniformly forming light shielding layers thick enough in forming the light shielding layers of a lenticular lens sheet the pitch of which is particularly small is demanded.

### DISCLOSURE OF THE INVENTION

### Problem to be Solved by the Invention

An object of the invention in view of the above-mentioned problem is to provide a lenticular lens sheet that allows to easily form light shielding layers which realize high contrast performance even if the pitch of lenticular lens rows is small.

### Means for Solving the Problem

The invention for solving the problem is based upon a lenticular lens sheet having rows of cylindrical lenses on the incident surface side, having protrusions on those sections of the lens rows where light is not condensed, and having light absorption layers on the protrusions, wherein the pitch of the lens rows is smaller than 0.5 mm, the angle θ1 between the lowermost section of the protrusion and a sheet main surface is equal to or greater than 45° and is greater than the angle θ2 formed between the vertex of the protrusion and the sheet main surface, and the width of the protrusion measured at a position 10 μm away in the sheet thickness direction from the vertex of the protrusion is equal to or smaller than 150 μm.

Besides, in the lenticular lens sheet according to the invention, the sectional shape of the vertex of the protrusion is a part of an approximate circle.

Besides, in the lenticular lens sheet according to the invention, the radius of curvature at the vertex of the protrusion having the approximately circular sectional shape is 1 mm or smaller.

Further, in the lenticular lens sheet according to the invention, an angle between the lowermost section of the protrusion and the sheet main surface is equal to or more than 60° and is less than 90°.

Furthermore, in the lenticular lens sheet according to the invention, the width of the protrusion measured at a position 10 μm away in the sheet thickness direction from the vertex of the protrusion is equal to or smaller than 80% of the width in the lowermost section of the protrusion.

### EFFECT OF THE INVENTION

According to the invention, since a light shielding layer thick enough formed on the protrusion of a lenticular lens can be easily and uniformly formed even if the pitch of the lenticular lens rows is small, the contrast of external light can be enhanced. Besides, the shape of the protrusion that does not screen video light outgoing from the lenticular lens can be acquired. Further, since the light shielding layer is not excessively thick, a problem of the hardening of ink hardly occurs. Furthermore, since the shape of the protrusion has only to have the shape according to the invention, the shape of the lens is not required to be changed.

### BRIEF DESCRIPTION OF THE DRAWINGS

FIG. 1 is a schematic diagram showing a rear projection screen;

FIG. 2 shows relation between the pitch of lens rows in prior art and the thickness of ink;

FIG. 3 shows relation between the thickness of applied ink and light transmittance;

FIG. 4 shows the sectional shape of a protrusion in the prior art;

FIG. 5 shows the sectional shape of a protrusion in one embodiment of the invention;

FIG. 6 shows the sectional shape of a protrusion in one embodiment of the invention;

FIG. 7 shows the sectional shape of a light shielding layer in one embodiment of the invention;

FIG. 8 shows the sectional shape of a light shielding layer in one embodiment of the invention;

FIG. 9 is an illustration for explaining the width at the vertex of a protrusion in the invention;

FIG. 10 is an illustration for explaining angles θ1 and θ2 in the invention;

FIG. 11 shows the sectional shape of a light shielding layer in the prior art;

FIG. 12 shows an embodiment for manufacturing a lenticular lens sheet according to the invention;

FIG. 13 shows relation between a position of the protrusion and the thickness of ink in the embodiment of the invention and a comparative example;

FIG. 14 shows the sectional shapes of protrusions in first and second embodiments of the invention; and

FIG. 15 shows the sectional shapes of protrusions in third and fourth embodiments of the invention.

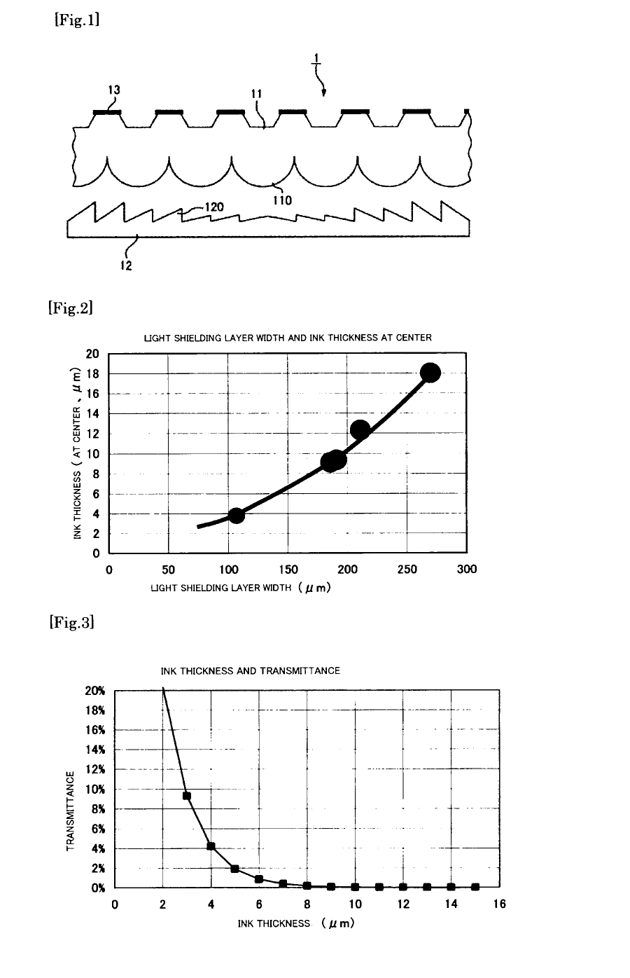

### BEST MODE FOR CARRYING OUT THE INVENTION

Referring to the drawings, best embodiments of the invention will be described below.

The width of a protrusion measured in a position apart by 10 μm in a sheet thickness direction from the vertex of the protrusion in the invention means a distance between a point and a point where a straight line parallel to a sheet main surface drawn in the position 10 μm away in the sheet thickness direction from the vertex of the protrusion on a cross section of the protrusion and a section of the protrusion cross as shown in FIG. 9, and is shown as width A in FIG. 9. It is found out that when the width A is larger than 150 μm, ink at an end of a flat part of the protrusion thins as shown by an arrow in FIG. 11 and contrast is deteriorated.

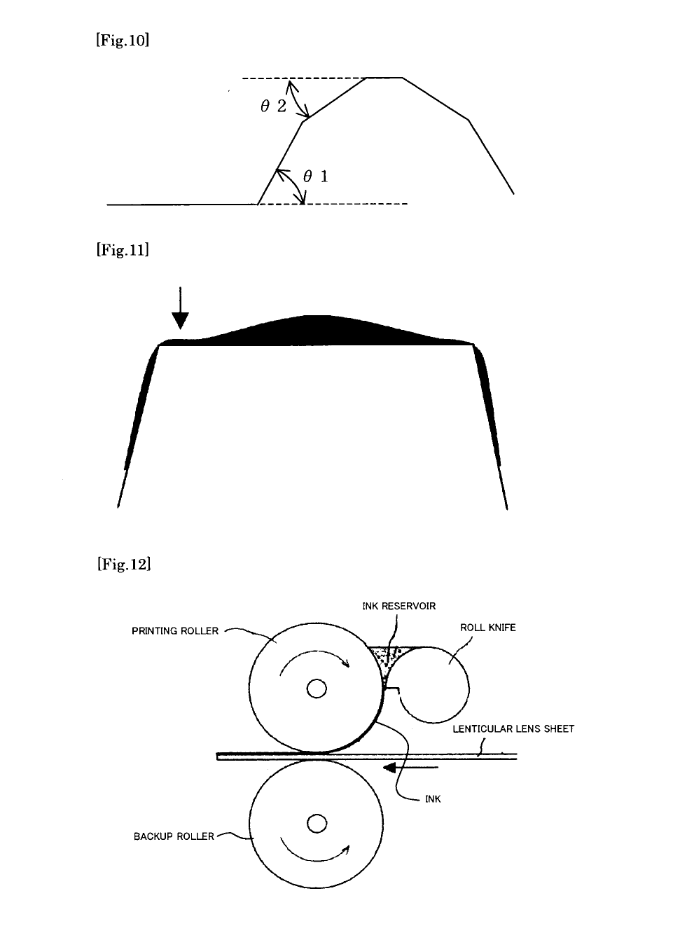

Referring to FIG. 10, angles θ1 and θ2 in the invention will be described below. As shown in FIG. 10, the angle θ1 is an angle between a slant face of the protrusion in the lowermost section of the protrusion and the sheet main surface and the angle θ2 is an angle between the vertex of the protrusion and the sheet main surface. The main surface means a virtual plane parallel to a screen when the screen is defined as a two-dimensional plane.

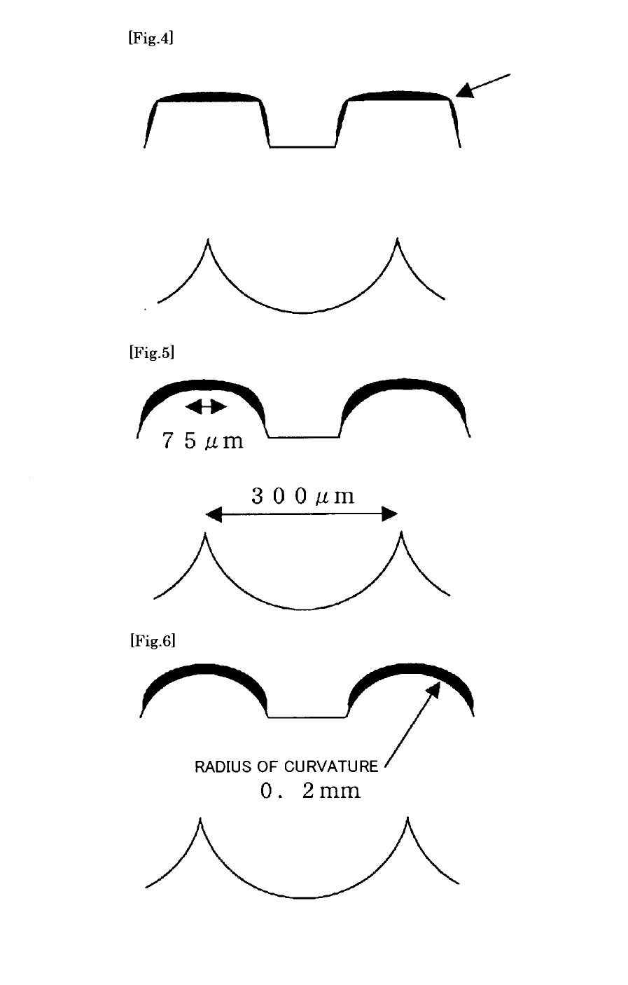

Referring to FIG. 5, one example of a lenticular lens sheet according to the invention will be described below. FIG. 5 is a schematic diagram showing one example of the lenticular lens sheet according to the invention. As shown in FIG. 5, the pitch of lens rows in the lenticular lens sheet in this example is approximately 300 μm and the length of a flat part in the vertex of a convex light shielding part is approximately 75 μm. Ink applied to the convex vertex rounds by surface tension; however, since the flat part is short, no location where the thickness of ink is not enough is made, and large contrast is produced.

FIG. 6 is a schematic diagram showing another example of the invention. The pitch in a lenticular lens sheet in this example is approximately 300 μm and is similar to that in FIG. 5. As shown in FIG. 6, a radius of curvature of a convex vertex is approximately 0.2 mm. In this case, the width of a protrusion apart by 10 μm from a vertex of the protrusion is approximately 125 μm. When a sectional shape of the protrusion is a smooth curve at the vertex as described above, an angle θ2 is 0°.

When the vertex of the protrusion has a specific round shape as described above, no location where the thickness of ink is not enough is similarly made and large contrast can be produced. Apart from the shapes shown in FIGS. 5 and 6, an arbitrary shape such as a polygon and a shape acquired by combining a polygon and a curve can also be taken.

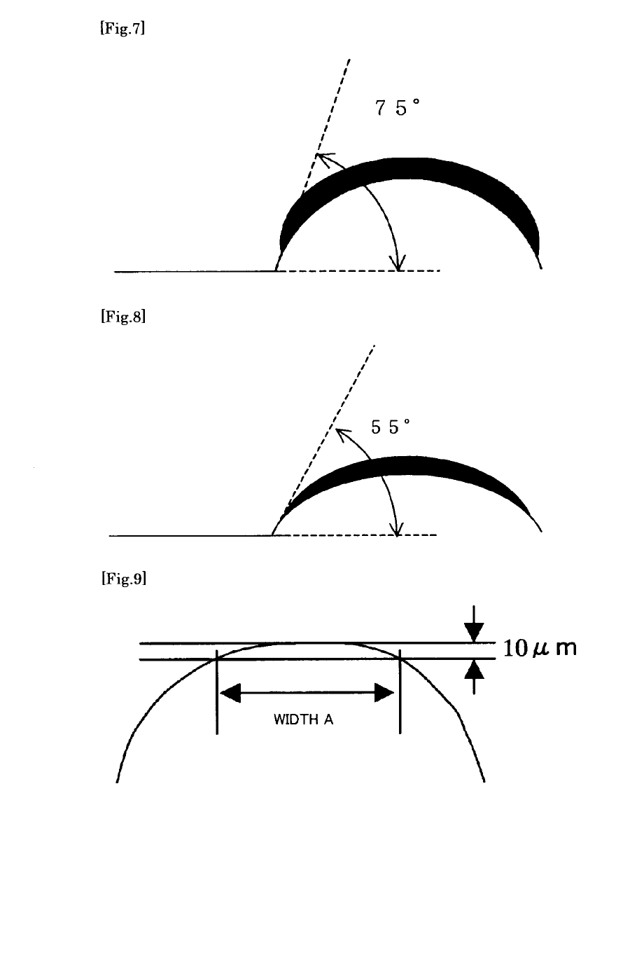

Further, it is desirable that an angle θ1 between the lowermost section of the protrusion and a sheet main surface is 60° or more. FIG. 7 shows one example of a lenticular lens sheet according to the invention. In this example, the angle θ1 is set to 75°. In the meantime, in an example shown in FIG. 8, an angle θ1 is 55°. When the angle θ1 is smaller than 60°, the apparent thickness viewed from the front of a light shielding layer of a slant face of a protrusion may be thinner as shown in FIG. 8.

When ink (hereinafter called UV ink) based upon ultraviolet hardened resin is used, the effect of the invention is remarkable. Generally, the UV ink has a problem that only the surface is hardened and the inside is not hardened when the thickness of application is increased and when the concentration of a light absorption agent such as carbon pigment is increased. Therefore, when the thickness of ink applied to the lenticular lens sheet is simply increased as shown in FIG. 4 and when the concentration of the light absorption agent is merely increased, a problem of a failure of ink hardening in a thick part occurs. In the lenticular lens sheet according to the invention, ink can be applied at uniform thickness without being too thick and without being too thin.

More concretely, the rate of area where the thickness of the light shielding layer is equal to or larger than 1 μm and is equal to or smaller than 10 μm can be 90% or more of the area covered with the light shielding layer.

The sectional shape of the protrusion in the invention means the shape when the protrusion is cut in a direction parallel to an arranged direction of the lens rows and perpendicular to a sheet surface.

A method of forming the lenticular lens sheet according to the invention may be any method. For example, extrusion molding and molding based upon ultraviolet hardened resin may be used.

A method of forming the light shielding layer of the lenticular lens sheet according to the invention may be any method. For example, roll printing and screen printing can be used. In particular, roll printing is desirable in that printing is possible, molding the lenticular lens sheet and a roll knife coater shown in FIG. 12 is particularly desirable in that the thickness of application is uniform and printing onto a slant face of the protrusion is also possible.

### First and Second Embodiments

A lenticular lens sheet having protrusions shown in FIG. 14 which have approximately circular vertexes and each one part including the lowermost section of which is formed in a linear slant face is to be produced. An angle between the lowermost section of the protrusion and a sheet surface is set to 85° as shown in FIG. 14. The width in the lowermost section of the protrusion is 70% of the lens pitch. The pitch of lenticular lenses in the first and second embodiments is respectively set to 0.265 mm and 0.311 mm. The minimum radiuses of curvature of the protrusion vertexes are set to 0.148 mm and 0.187 mm and the width of the protrusions in positions apart by 10 μm from the respective vertexes is respectively set to 103 μm and 124 μm. Afterward, ultraviolet hardened black ink is applied to the whole surfaces of the approximately circular protrusions using a roll coater shown in FIG. 12.

As a result of attaching the lenticular lens sheets equivalent to the first and second embodiments to a projection display and observing a projected image in a room where illuminance on a screen is 360 lux, a projected image excellent in contrast can be observed. Even if a projected image is observed in a state tilted by approximately 60° in a horizontal direction, no problem occurs.

### Third and Fourth Embodiments

A lenticular lens sheet shown in FIG. 15 having protrusions which have flat vertexes, each one part including the lowermost section of which is formed in a linear slant face and each intermediate part of which is a part of an approximate circular arc is to be produced. An angle between the lowermost section of the protrusion and a sheet surface is set to 85°. The pitch of lenticular lenses in third and fourth embodiments is respectively set to 0.265 mm and 0.311 mm. The width of the protrusions in positions apart by 10 μm from the vertexes is respectively set to 70 μm and 80 μm. Afterward, ultraviolet hardened black ink is applied to the protrusions using the roll coater shown in FIG. 12. The thickness after hardening of ink applied to each protrusion is 11 μm on the approximately whole surface.

When the lenticular lens sheets equivalent to these embodiments are attached to a projection display and a projected image is observed in a room where illuminance on a screen is 360 lux, a projected image excellent in contrast can be observed.

### Fifth Embodiment

A lenticular lens sheet is to be produced as in the first and second embodiments except that the pitch of a lenticular lens is set to 0.15 mm and the minimum radius of curvature of a protrusion vertex is set to 0.063 mm. The width of a protrusion in a position apart by 10 μm from the vertex is 68 μm. Afterward, ultraviolet hardened black ink is applied to the whole surface of the approximately circular protrusion using the roll coater shown in FIG. 12.

### Sixth Embodiment

A lenticular lens sheet having protrusions shown in FIG. 8 which are approximately circular from the vertex of the protrusion to the lowermost section is produced. An angle between the lowermost section of the protrusion and a sheet surface is set to 54°. The width of the lowermost section of the protrusion is 70% of the lens pitch. Pitch between lenticular lenses in a sixth embodiment is set to 0.295 mm. The minimum radius of curvature of the protrusion vertex is set to 0.118 mm and the width of the protrusion in a position apart by 10 μm from the protrusion vertex is set to 98 μm. Afterward, ultraviolet hardened black ink is applied to the whole surface of the approximately circular protrusion using the roll coater shown in FIG. 12.

### First and Second Comparative Examples

A lenticular lens sheet having the approximately trapezoidal protrusions shown in FIG. 4 is produced. An angle between the lowermost section of the protrusion and a sheet surface is set to 85°. The pitch of lenticular lenses in comparative examples 1 and 2 is respectively set to 0.265 mm and 0.311 mm and the width of the protrusions in positions apart by 10 μm from vertexes is respectively set to 160 μm and 190 μm. Afterward, ultraviolet hardened black ink is applied to the trapezoidal protrusions using the roll coater shown in FIG. 12.

As a result of attaching the lenticular lens sheets in the first and second comparative examples to a protrusion display and observing a projected image in a room where illuminance on a screen is 360 lux, contrast is inferior to that of the lenticular lens sheets equivalent to the first and second embodiments. When a projected image is observed in a state tilted by approximately 60° in a horizontal direction, a problem that the image is dark occurs. Further, the hardening of ink is insufficient at the vertex of the protrusion.

Table 1 shows one example of a result of measuring luminance by scattered reflected light at the front of each center of the lenticular lens sheets in the room where a projected image is observed so as to evaluate contrast on the screen. The illuminance on the screen is 360 lux like evaluation by visual observation.

TABLE 1

| | | Reflection | |
|---|---|---|---|
| | Lens row pitch | luminance | Improvement |
| | (mm) | (cd/cm²) | ratio |
| First | 0.265 | 2.88 | −24% |
| embodiment | | | |
| Second | 0.311 | 3.77 | (Criterion) |
| comparative | | | |
| example | | | |

Table 1 shows that luminance by scattered reflected light on the screen in the first embodiment, that is, blackness is improved by 24%, compared with that on the screen in the comparative example 2.

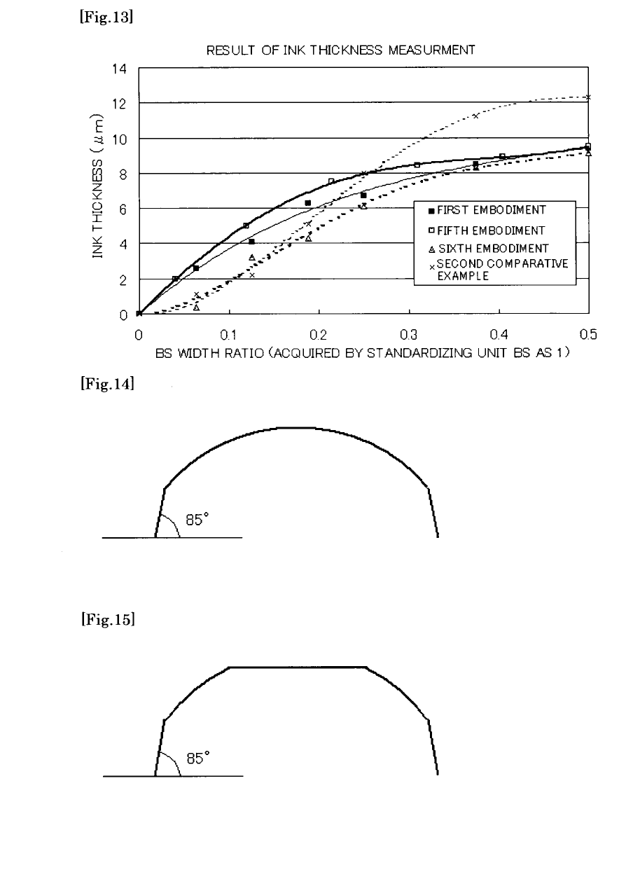

FIG. 13 shows one example of a result of measuring the thickness of hardened ink. On the x-axis in FIG. 13, values acquired by standardizing the width to which black ink is applied as 1 are shown.

As for the lenticular lens sheet having the pitch of 0.295 mm in the sixth embodiment, the area where the black ink is applied to be 1 μm or more thick is approximately 86% and there is no part in which black ink is applied to be 10 μm or more thick. Therefore, there is no part where black ink is applied such excessively thickly that the hardening of ink is obstructed, and ink is applied in large area to be thick enough.

As for the lenticular lens sheet having the pitch of 0.15 mm in the fifth embodiment, the area where black ink is applied to be 1 μm or more thick is approximately 96% and there is no part where black ink is applied to be 10 μm or more thick. Therefore, there is no part where black ink is applied such excessively thickly that the hardening of ink is obstructed, and ink is applied in large area to be thick enough.

As for the lenticular lens sheet having the pitch of 0.265 mm in the first embodiment, area where black ink is applied to be 1 μm or more thick is approximately 95% and there is no part where black ink is applied to be 10 μm or more thick. Therefore, there is no part where black ink is applied such excessively thickly that the hardening of ink is obstructed, and ink is applied in large area to be thick enough.

In the meantime, as for the lenticular lens sheet having the pitch of 0.311 mm in the second comparative example, the area where black ink is applied to be 1 μm or more thick is approximately 84% and is smaller than the area in the embodiments. Parts where black ink is applied to be 10 μm or more thick are approximately 35% and in these parts, a failure of the hardening of ink occurs.

As described above, according to the invention, as the light shielding layer thick enough formed on the protrusion of the lenticular lens can be easily and uniformly formed even if the pitch in the lenticular lens sheet is short, the contrast of external light can be enhanced. The protrusion can have such a shape that outgoing light is screened. As the light shielding layer is not excessively thick, no problem of the hardening of ink occurs.

1. A lenticular lens sheet comprising:
rows of cylindrical lenses on the incident surface side;
protrusions on those sections of the lens rows where light is not condensed, and
light absorption layers on the protrusions,
wherein the pitch of the lens rows is smaller than 0.5 mm,
the angle θ1 between the lowermost section of the protrusion and a sheet main surface is equal to or greater than 45° and is greater than the angle θ2 formed between the vertex of the protrusion and the sheet main surface, and
the width of the protrusion measured at a position 10 μm away in the sheet thickness direction from the vertex of the protrusion is equal to or smaller than 150 μm.

2. The lenticular lens sheet according to claim 1,
wherein the sectional shape of the vertex of the protrusion is a part of an approximate circle.

3. The lenticular lens sheet according to claim 2,
wherein the radius of curvature at the vertex of the protrusion having the approximately circular sectional shape is 1 mm or smaller.

4. The lenticular lens sheet according to claim 1,
wherein an angle between the lowermost section of the protrusions and the sheet main surface is equal to or more than 60° and is less than 90°.

5. The lenticular lens sheet according to claim 1,
wherein the width of the protrusion measured at a position 10 μm away in the sheet thickness direction from the vertex of the protrusion is equal to or smaller than 80% of the width in the lowermost section of the protrusion.
